(19) United States
(12) Patent Application Publication
(10) Pub. No.: US 2006/0011093 A1
(43) Pub. Date: Jan. 19, 2006

(54) Conveyor and a method of providing a driving force to a conveyor

(76) Inventors: Viggo Jensen, Hinnerup (DK); Torben Bjornholt, Abyhoj (DK); Henrik Miller, Hinnerup (DK); Dennis Sorensen, Hammel (DK)

Correspondence Address: BIRCH STEWART KOLASCH & BIRCH, PO BOX 747, FALLS CHURCH, VA, 22040-0747, US

(21) Appl. No.: 10/626,581

(22) Filed: Jul. 25, 2003

Related U.S. Application Data
(60) Provisional application No. 60/398,593, filed on Jul. 26, 2002.

(30) Foreign Application Priority Data
Jul. 26, 2002 (DK) PA 2002 01147

(51) Int. Cl. B60L 13/04

(52) U.S. Cl. 104/282; 198/619

(57) ABSTRACT

The invention relates to a conveyor (100) that has a number of carts (102) moving along a track (101). A propulsion system for the conveyor comprises a stationary stator (411) which has a coil assembly. In addition the carts (102) have a reaction element (200) comprising a plurality of permanent magnets (203) mounted on a ferromagnetic carrier plate (201) thereby providing a magnetic field. A controller (607) controls the a supply of electrical power to the coil assembly such that a magnetic field is generated which interacts with that of the permanent magnets to provide a driving force.

### FIELD OF THE INVENTION

The invention relates to a conveyor and a method of providing a driving force to a conveyor, and in particular for a conveyor for an article sorting mechanism for sorting articles such as parcels and baggage.

### BACKGROUND OF THE INVENTION

Automatic sorting of articles, such as baggage, packets and parcels and the like has in recent years become increasingly advantageous. Most national and international parcel delivery services and mail services today operate large distribution centres wherein automatic or semiautomatic sorting of parcels according to their destination is performed. Similarly, many baggage handling systems, such as for example for airports, use automatic sorting systems.

An important part of such baggage handling or parcel sorting centres is a conveyor for automatically moving the articles to the desired location in the distribution centre appropriate for the given destination.

Such conveyors typically have a number of carts/article supporting units driven by a transport mechanism. An article in the form of e.g. a parcel or baggage is placed on a cart and driven round a track by the transport mechanism. When the article reaches the appropriate location for the given destination, the article is loaded of the track. Typically, the loading of the article on and of the cart is automatic, for example by moving an article supporting surface in a direction perpendicular to the conveying direction or by a tipping motion being imported to the platform/article supporting surface supporting the article.

In older conveyor systems, the transport mechanism is typically a mechanical system wherein a belt or chain is moved around a given track. The belt or chain mechanically interacts with carts to push or pull them around the track and may additionally act as a guide mechanism for the carts. However, as this is costly, consumes high power, requires high maintenance and is unreliable, recent systems have attempted to improve by using driving mechanisms based on electromagnetic forces.

Movement induced by magnetic fields is known from motor applications. As an example DE 195 03 511 C2 discloses a synchronous linear motor comprising a primary part having coil windings and a secondary part having a plurality of permanent magnets separated by cross-pieces.

U.S. Pat. No. 5,664,660 discloses a sorter conveyor having laterally tiltable transport trays. Instead of a conventional transport chain driven by driving station, trays are advanced by way of stationary linear motors evenly distributed along a guiding chassis.

### SUMMARY OF THE INVENTION

It is an object of a preferred embodiment of the invention to provide an improved conveyor system.

Accordingly, there is provided a conveyor comprising: a chain of carts for carrying items, a track along which the chain of carts may be driven, a propulsion system for providing a driving force to the chain of carts for moving the carts along the track, the propulsion system comprising: at least one stationary stator comprising a coil assembly whereby a first magnetic field may be generated by the coil assembly when electrical power is applied to the coil assembly, at least one reaction element mounted on the chain of carts, the reaction element comprising a plurality of permanent magnets mounted on a ferromagnetic carrier plate, the permanent magnets thereby providing at least a second magnetic field, and a controller for controlling a supply of electrical power applied to the coil assembly such that the first and second magnetic fields interact to provide the driving force.

The inventors of the current invention have realised that it is feasible and advantageous to build conveyor systems with such low tolerances and careful control of the electrical power applied to coil assemblies that chains of carts can be driven by use of permanent magnets. Compared to conventional conveyor systems, wherein cart dimension tolerances and control accuracy lead to a design, wherein driving forces must be generated from induction currents that are caused by a generated magnetic drive field in order to ensure synchronisation, the current invention provides a system wherein cart tolerances and conveyor control is such that a magnetic drive field can accommodate a magnetic field from permanent magnets.

A significant advantage is that by using permanent magnets, losses due to induction currents can be reduced thereby providing a significantly increased efficiency. Experiments have shown that around 60-75% of the supplied electrical energy can be transformed into mechanical energy compared to typical values of around 10 to 15% for conventional magnetic conveyor drive systems. As conveyors typically operate continuously and carry heavy loads, this efficiency improvement represents a significant cost saving.

Preferably the first magnetic field is controlled such that as a cart moves, the magnetic field changes with the changes in magnetic field caused by the movement of the permanent magnets. Preferably this is achieved by the electrical power supplied to the coil assembly varying such that the resulting first magnetic field varies at a frequency commensurate with the magnetic field change caused by the permanent magnets moving at the given speed.

The permanent magnets and stators are preferably located relative to each other such that the optimal driving force is generated.

In accordance with a feature of the invention, a gap between the stator and the reaction element is at most 5 mm at a position of the reaction element where it is in its closest position with respect to the stator. Hence, preferably the carts, the stators and any other element of the conveyor are designed such as to allow for a very small gap between stator and reaction element. This provides for very strong magnetic forces being generated, resulting in a significant driving force being generated at relatively low power consumption levels. Further, as the magnetic fields due to the close position of the stator and the reactor elements are reduced compared to larger gaps, the magnetic field is constrained within a smaller area. A significant advantage of this is that the magnetic field at the position of the load is reduced whereby the impact on any magnetic sensitive load is minimised. Preferably, the gap is less than 5 mm for all stators of the conveyor but in practical implementations some stators may be mounted such that they result in a wider gap than other stators.

In accordance with one feature of the invention, the gap between the stator and the reaction element is between 1.2 and 4 mm at the position of the reaction element where it is in its closest position with respect to the stator. Extensive experiments have shown that this is an optimal range for conveyor systems, and in particular for conveyors for parcel sorting or baggage handling. The range provides for the use of magnetic fields that result in a sufficient drive power for a conveyor yet is sufficiently low not to provide a high magnetic field at the position of the load. Especially for parcel sorting or baggage handling this is important as the content of the parcels, baggage and the like may be unknown and may comprise magnetic sensitive materials such as diskettes or hard disks. At the same time, the range allows for design and manufacturing tolerances that are suitable for high accuracy conveyor systems.

In the design of an embodiment of a conveyor system of the invention, it is important to design the gap between reaction element and stator such that the inevitable manufacturing and wear tolerances do not result in an unreliable system. If the gap is insufficient, the reaction element will be in such close proximity of the stator that the transversal magnetic forces become too large compared to the longitudinal driving force. This can increase friction and thus reduce the efficiency of the system. In the worst case an insufficient gap can result in the production and wear tolerances resulting in the stator and reaction element coming into physical contact with each other, which at best causes unacceptable friction but in most case will result in damage to the system. However, in order to achieve a high efficiency and low magnetic field at the load position, it is important that the gap is so low that a sufficient drive force is achieved by preferably a relatively low field strength of the first and/or second magnetic field. The performance of the conveyor system is thus highly dependent on the gap between the stator and reaction element and the inventors have found that a gap between 1.2 mm and 4 mm is optimal for most systems.

Preferably, the gap between the stator and reaction element at the closest point is predominantly an air gap. However, the gap may comprise or exclusively consist in other materials. These materials preferably provide a low friction between the stator and the reaction element and may assist or control the guiding of the moving elements relative to the static elements. Further, in some cases the materials may be of magnetic material, such as magnetic rubber, whereby the magnetic field strength is increased yet increasingly confined.

In accordance with another feature of the invention, the conveyor is arranged to convey and sort articles. Hence, the conveyor system as described is preferably designed to meet all the requirements of a system for sorting articles and in particular for sorting parcels in a parcel distribution system. Alternatively or additionally, the conveyor system is preferably designed to meet all the requirements of a system for handling baggage. This provides for a sorting system having a highly efficient conveyor which consumes significantly less power and thus provides a significant reduction in the running cost for the sorting system.

In accordance with another feature of the invention, the chain of carts/article supporting units is an endless chain. Preferably all carts are interlocked with other charts whereby driving forces applied to one cart are transferred to other carts through the interlocking means. For an endless chain, the driving forces can be applied to any suitable carts and there is no need for special consideration of the beginning or end of a link. Further, an endless link provides for a continuous conveyor wherein a load platform is always available at any position of the track.

In accordance with another feature of the invention, the at least one reaction element comprises a number of reaction elements equal to the number of carts in the chain, whereby each cart is provided with one such reaction element. Preferably, each of the carts have a reaction element such that regardless of which cart is adjacent a stator, a driving force is applied to the chain. As the chain of charts moves, a different cart will be adjacent the stator but as this additionally has a reaction element, the driving force will continue to be applied.

Specifically, if the reaction element substantially extends to the length of the cart an almost continuous magnetic field of high strength is generated by the reaction elements. This provides for a continuous and thus very smooth driving force to be exerted on the chain of carts resulting in smooth movement of the cart. This is specifically important for conveyors where mechanical shock and vibration must be minimised due to sensitive loads.

The reaction element may in some cases comprise a number of sub-elements. Specifically, each of the sub-elements may comprise a plurality of permanent magnets and may have a fixed length. The ending of the sub-elements is preferably such that when the ends of two sub-elements are placed next to each other, a homogenous magnetic field is formed over the transition. Specifically, the sub-elements are formed such that the distance between permanent magnets within a sub-element is substantially equal to the distance between permanent magnets of different sub-elements, when placed so as to abut each other. This is advantageous as it allows for a reaction elements to be fitted to the entire length of carts of different lengths using sub-elements of a fixed length. Thus storage and manufacture of reaction elements can be limited to a single length while still providing flexibility for adapting to carts of different lengths.

According to a different embodiment of the invention, the conveyor comprises a plurality of stators arranged at intervals-along the track. Preferably, the intervals are larger than the length of the carts such that the driving force is only applied to a subset of the carts of the chain. Preferably, the driving force is transferred to the other carts through interlocking means. The interval is therefore preferably lower than the length of the chain such that at any given time at least one stator provides a driving force to at least one of the carts of the chain. A significant advantage of positioning the stators at intervals is that it is not required to have stators positioned throughout the track but rather stators can be positioned at intervals while still ensuring that a driving force can be exerted on the chain. Therefore, a reduced number of stators are required resulting in lower cost and reduced power consumption.

The stator may further be divided into drive elements each containing at least one coil assembly. These drive elements can be supplied electrical power from a controller and can specifically be supplied electrical power by a parallel connection or a serial connection of the coils of the different drive elements. Especially, for a parallel coupling only a subset of the elements may be used at a given time and a frequency of the variations in the electrical power may be changed accordingly. An advantage of using separate drive elements of a stator is that the driving force can be increased and extended over a longer stretch by using a plurality of coil assemblies while not significantly increasing the complexity of the control equipment required.

According to one feature of the invention, the plurality of stators is arranged substantially equidistantly along the track. This provides for a smooth driving force and thus a smooth movement of the carts of the chain.

According to another feature of the invention, the controller is operable to control a speed of the chain of carts by controlling a frequency of a voltage applied to the coil assembly. Preferably, electrical power is supplied in the form of a sinusoidal having a suitable frequency and power. The frequency is adjusted such that it corresponds to the magnetic field changes of the field generated by the moving permanent magnets. Preferably, when increased speed is required, the power level of the electrical power supplied is increased and the frequency is increased corresponding to the increased speed. Likewise, reduced speed is achieved by decreasing the power level and the frequency accordingly. In some embodiments, the speed may be adjusted by frequency variations without changing the power, and in some embodiments the speed may be adjusted by power variations without changing the frequency. This is particular suitable for small momentary speed variations.

According to a preferred feature of the invention, the controller comprises a control system for controlling the operation of the propulsion system, the control system comprising a variable frequency inverter for controlling the electrical power applied to the coil assembly. Hence, a low complexity and low cost implementation preferably uses a variable frequency inverter for generating the frequency changes and/or power level changes required for controlling the movement of the chain of carts.

According to another feature of the invention the control system is comprised in an industrial network. Thus, advantageously the control system is designed such that it meets all the requirements for interfacing with an industrial network thereby allowing the control system to be controlled remotely through the industrial network.

According to a different feature of the invention, the controller further comprises an encoder for determining a position of at least one cart of the chain of carts, and the controller is operable to control the electrical power applied to the coil assembly in response to the determined position. Alternatively or additionally, the controller further comprises an encoder for determining a speed of at least one cart of the chain of carts, and the controller is operable to control the electrical power applied to the coil assembly in response to the determined speed.

Preferably, the encoder is placed in connection with a stator such that when a position and/or a speed of a cart is detected, this is used to synchronise the magnetic field of the stator to the magnetic field of the permanent magnets. Specifically, the location determination can be used to set a phase of the frequency of the electrical supply creating the first magnetic field, and the speed can be used to set the frequency of the electrical supply creating the first magnetic field. The location detection may simply detect the presence of a cart and determine the location of the cart to be at the encoder when the detection is made. In some implementations, only one of the parameters of location or speed of a cart is detected by the encoder. Preferably, in these cases, the other parameter is determined by other means. For example, the speed of movement of a cart may be indirectly determined from determination of the speed of movement of other charts of the chain. The encoder provides a low complexity and low cost method of synchronising the first magnetic field with the second magnetic field. Further, accurate synchronisation can be achieved in this way resulting in improved drive performance and increased efficiency.

In accordance with a preferred feature, the encoder is mounted in a magnetically shielded housing. This allows the impact of the magnetic field on sensitive measurement circuitry of the encoder to be reduced. This is of particular advantage when the encoders are placed in close proximity to the strong magnetic field created by a stator.

In accordance with another feature of the invention, the at least one stationary stator comprises at least two drive elements each having a coil assembly and the encoder is mounted between two adjacent drive elements. This provides for a very accurate position and/or speed determination when the cart is adjacent the elements of the stator thereby allowing for optimisation of the synchronisation as the estimates are generated for the cart in the position where the first and second magnetic fields are interacting.

Preferably, each stator of the propulsion system is capable of providing a driving force of at least 350 N. In a typical conveyor, a driving force of 400 N under normal drift is suitable increasing to 800 N during acceleration or deceleration of the carts. Hence, conveyors with chains of around 40 carts of a length of 750 mm each carrying an average load of approximately 10 kg up to a maximum of around 40 kg is suitable for a conveyor for e.g. a parcel sorting or baggage handling system. Experiments have shown that the driving force per cart in this case preferably is between 5 and 10 N requiring a total drive force of 200 N-400 N. The required driving force may vary in accordance with the dimension of the cart, the characteristics of the track, the variations in the weight of carts and especially loads and the level variations over the track; and experiments have shown that for a suitable conveyor the driving force per stator is preferably at least 350 N. Higher driving forces can furthermore be achieved by use of additional stators albeit at an increased cost.

According to a feature of the invention a magnetic flux induced by the propulsion system is at most 0.8 kA/m in a distance of 0.2 m from the stator, and the at least one reaction element. Preferably, at least one cart of the chain of carts comprises magnetical shielding material. Hence, in a preferred implementation, the magnetic field level is reduced so as to reduce the impact on magnetically sensitive material which may be carried by the carts. This specifically includes magnetic tapes, hard disks, floppy discs and other magnetic storage means. Experiments have shown that a flux level of at most 0.8 kA/m at a distance of 0.2 m from the stator is achievable for conveyors, and that this results in a reasonable protection for most sensitive loads. The magnetic flux may be reduced by use of shielding material which may comprise part of the cart or may be additional material added to a cart. Specifically, only a subset of carts of a chain may be magnetically shielded and these carts can be used for magnetically sensitive loads.

According to a second aspect of the invention, there is provided a method of providing a driving force to a conveyor comprising: a chain of carts for carrying items, a track along which the chain of carts may be driven, a propulsion system for providing a driving force to the chain of carts for moving the carts along the track, the propulsion system having at least one stationary stator and at least one reaction element mounted on the chain of carts, the reaction element comprising a plurality of permanent magnets mounted on a ferromagnetic carrier plate thereby generating at least one reaction magnetic field, the method comprising: generating a first magnetic field in a coil assembly of the at least one stationary stator by applying electrical power to the coil assembly, and controlling the supply of electrical power applied to the coil assembly such that the first magnetic field and the at least one reaction magnetic field interact to provide the driving force.

According to a feature of the invention the step of controlling the supply of electrical power comprises controlling a speed of the chain of carts by controlling a frequency of a voltage applied to the coil assembly.

According to another feature of the invention, it further comprises the step of determining a position of at least one cart of the chain of carts, and wherein the control of the supply of electrical power is in response to the determined position.

According to another feature of the invention, the method further comprises the step of determining a speed of at least one cart of the chain of carts, and wherein the control of the supply of electrical power is in response to the determined speed.

According to a third feature of the invention, there is provided a cart for a conveyor having a propulsion system, the cart comprising: a frame structure, at least one magnetic reaction element comprising a plurality of permanent magnets mounted at intervals on a ferromagnetic carrier plate, a protective cover of a non-magnetic material covering the permanent magnets for protection against mechanical impact. Permanent magnets are typically fragile and not well suited for moving systems wherein mechanical impact may occur. The protective cover provides a protection of the magnets such that the disadvantage of mechanical impact is mitigated. The protective cover preferably covers the edges of the permanent magnet so as to provide protection against chipping of the corners or edges. However, in some embodiments the protective cover does not extend over the entire permanent magnet. This allows for ease of manufacturing as a complete cover is not required and further provides a saving in non-magnetic material. A further advantage provided by the cover is that various magnetic elements, such as e.g. nails and screws, which are attracted by the permanent magnets, can be removed without scratching or chipping the magnet.

According to a feature of the invention the plurality of permanent magnets are mounted substantially equidistantly. This provides for a very homogenous second magnetic field to be created which, when the cart is moving, results in magnetic field variations that are continuous and preferably substantially sinusoidal. This provides a second magnetic field suited for the interaction of a first magnetic field generated from a sinusoidal electrical power supply. As a result, improved performance and efficiency is achieved while maintaining low cost through a low complexity electrical power supply.

According to another feature of the invention, the protective cover comprises a plastic coating. This is a low cost material with very suitable protection and attachment properties that are easy to apply and handle during the manufacturing process.

According to another feature the protective cover is integral with a plastic filling which fills the intervals between the magnets.

Preferably the protective cover and the plastic filling are integral with at least one plastic element for fastening the carrier plate to the frame structure. Hence, a simple and low cost manufacturing process is achieved wherein the protective cover preferably has a second function of affixing the permanent magnets to the cart through the use of a carrier plate. Hence, a reaction element may be produced with a protective cover and affixed to a carrier plate in one manufacturing process. The reaction element may then in a separate process, possibly following storage or in a different location, by fixed to a cart using the carrier plate.

According to one feature of the invention, each magnet is covered by a separate coating. This provides substantial protection of each element while providing for a simple coating process which has low use of coating material.

According to another feature of the invention, the cart further comprises a fastening element for fastening the carrier plate to the frame structure. This provides a simple mechanism for fixing the reaction element to the cart while allowing this to be done in a separate step from the manufacturing of the reaction element.

According to a fourth aspect of the invention, there is provided a method of securing a carrier plate to a frame structure of a cart for a conveyor, the cart comprising: at least one magnetic reaction element comprising a plurality of permanent magnets mounted at intervals on a ferromagnetic carrier plate, a protective cover of a plastic material covering the permanent magnets for protection against mechanical impact, the method comprising: arranging the carrier plate in a predetermined position with respect to the frame structure, providing the plastic material in a liquefied state to the carrier plate such that the plastic material covers the permanent magnets and, once solidified, provides a fastening connection between the carrier plate and the frame structure.

Hence, preferably a very simple and cost effective method of manufacturing is used for the reaction elements wherein permanent magnets on a carrier plate may be positioned in a frame after which liquid plastic is poured over the whole structure. When solidified the plastic both provides a protective cover as well as at least assists in fixing the carrier plate to the frame structure. Advantages include a reduction in size and weight of the resulting reaction element.

### BRIEF DESCRIPTION OF THE DRAWINGS

An embodiment of the invention will be described, by way of example only, with reference to the drawings, in which

FIG. 1 is an illustration of a conveyor in accordance with an embodiment of the invention,

FIG. 2 illustrates a view of a reaction element in accordance with an embodiment of the invention,

FIG. 3 illustrates a perspective view of a part of a cart of a preferred embodiment if the invention,

FIG. 4 is edge view of a cart in accordance with a preferred embodiment of the invention when in position on a track,

FIG. 5 illustrates an example of a stator in accordance with an embodiment of the invention,

FIG. 6 illustrates the electrical control system for a stator of a conveyor in accordance with a preferred embodiment of the invention,

FIG. 7 illustrates a reaction element being mounted in a frame structure with a protective cover in accordance with an embodiment of the invention,

FIG. 8 is a close up of the reaction element and mounting of the embodiment of FIG. 7,

FIG. 9 illustrates a reaction element according to a different embodiment of the invention, and

FIG. 10 is a close up of the reaction element of the embodiment of FIG. 9.

### DETAILED DESCRIPTION OF A PREFERRED EMBODIMENT

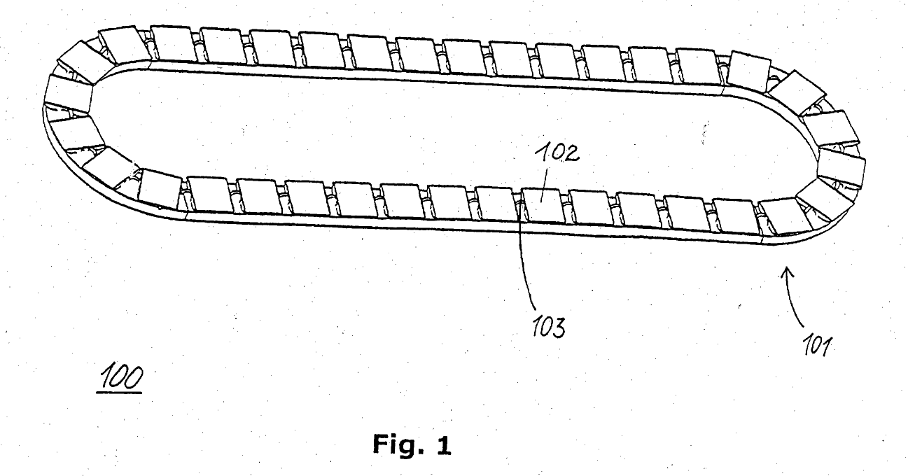

FIG. 1 shows an example of a conveyor 100 which is suitable for carrying loads. The conveyor 100 comprises a track 101 along which the carts (article supporting unit) 102 move. The track 101 is shown as an oval track in FIG. 1, but in various embodiments it will be laid out to suit the local conditions and requirements. A number of carts 102 move along the track. Each of the carts 102 has a load bearing platform on which a load (article) to be transported is placed.

The carts are interconnected by interlocking means 103 which typically comprise a rigid locking rod maintaining a fixed distance between the carts 102, and ensuring that the movement of a cart is transferred to the surrounding carts by a pulling or pushing action. The carts form a chain and specifically as shown in FIG. 1, they may form an endless chain covering the entire length of the track.

In the preferred embodiment, the conveyor is used in a parcel sorting system for a parcel distribution centre, and the loads carried by the conveyor are parcels of different sizes and weights. In another embodiment the conveyor is used in a baggage handling system, and the loads carried are baggage, such as suitcases. The baggage or parcels are automatically loaded to the load bearing platforms of the carts by a suitable conveyor belt or lifting apparatus. They are then transported to the appropriate location along the track where the baggage or parcel is automatically unloaded by the load bearing platform of the cart tipping such that the load slides of the platform or alternatively by moving the load bearing platform in a direction substantially perpendicular to the conveyance direction. The location along the track where the article is loaded depends on the destination of the article, and thereby articles having the same destination are collected together.

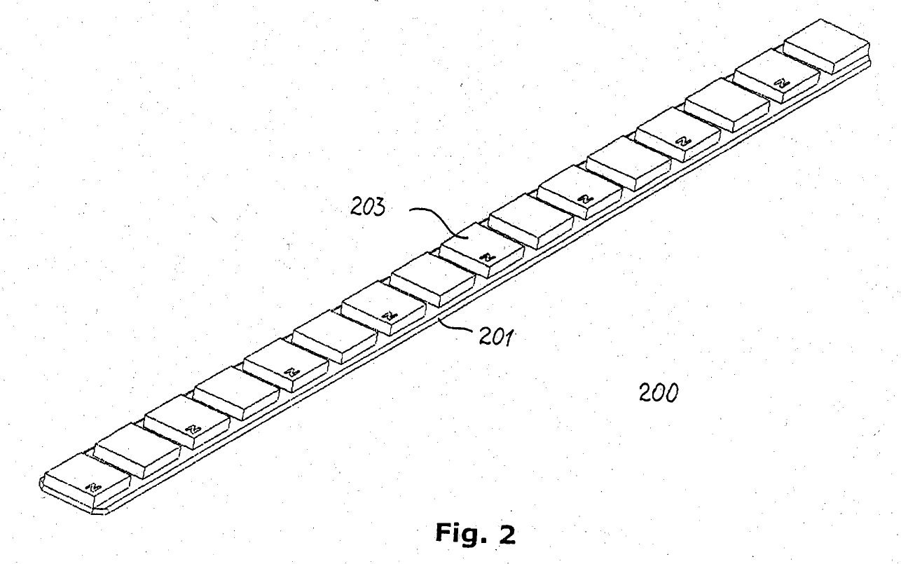

FIG. 2 illustrates a view of a reaction element 200 in accordance with an embodiment of the invention.

The reaction element 200 comprises a ferromagnetic carrier plate 201 upon which is fixed a plurality of permanent magnets 203. The permanent magnets are arranged such that the poles are aligned with the longitudinal direction of the carrier plate, and such that corresponding poles all face in the same direction, i.e. all the north poles are directed towards one end of the carrier plate, and all south poles are directed towards the opposite end of the carrier plate. The reaction element 200 thus creates a strong magnetic field resulting from the plurality of permanent magnets.

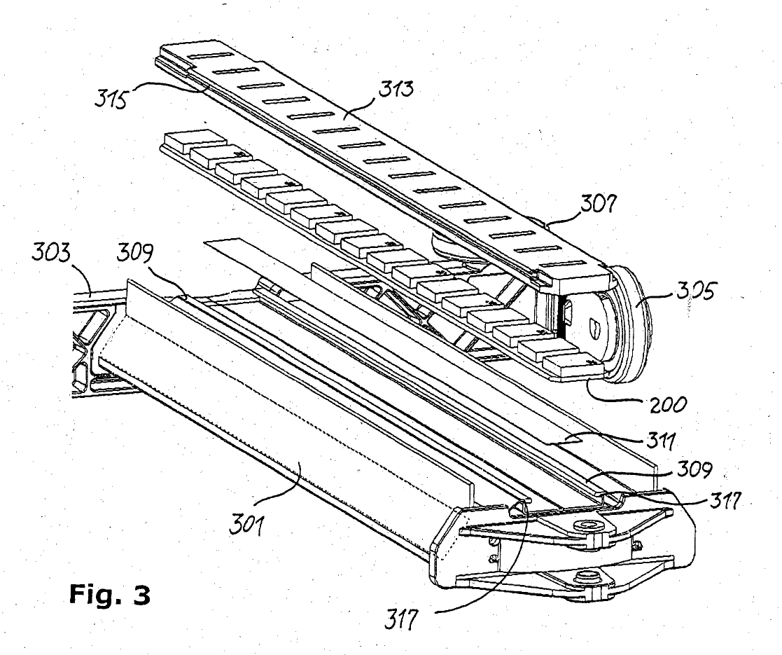

FIG. 3 illustrates a perspective view of a part of a cart 102 of a preferred embodiment of the invention. The cart 102 is in an upside down position compared to the operational position. The cart 102 comprises a longitudinal structure 301 connected to a transversal member 303. A second transversal member (not shown) is connected to the opposite end of the longitudinal structure. On each side of the transversal member 303 is mounted two wheels 305, 307 (only one side shown). The first set of wheels 305 are vertically mounted and supports the weight of the cart 102 when in use. The second set of wheels 307 is horizontally mounted and limits the sideways motion of the cart. Specifically, in use, the second set of wheels abuts guide rails ensuring that the cart stays on the track.

The longitudinal structure 301 comprises a frame structure 309 for receiving a reaction element 200. FIG. 3 illustrates a principle of mounting of a reaction element 200 in accordance with an embodiment of the invention. In this embodiment a shielding layer of non-magnetic material 311 is placed between the reaction element 200 and the frame structure 309. After the shielding layer and the reaction element have been lowered into the frame structure, a plastic cover element 313 is positioned over the reaction element thereby providing protection against mechanical impact. At the same time, the cover element 313 may provide fastening of the reaction element. In the embodiment shown in FIG. 3, the cover element 313 complements the cross section of the frame structure 309 such that fastening is achieved by flanges 315 of the frame structure 309 abutting edges 317 of the cover element when in position in the frame structure 309, thereby biasing the cover element 313, and thus the reaction element 200, against the frame structure 309. In this embodiment, the reaction element and cover element may be mounted by a sliding operation into the frame structure 309.

In other embodiments, other fixation and fastening methods may be used including gluing, screwing or any other suitable method.

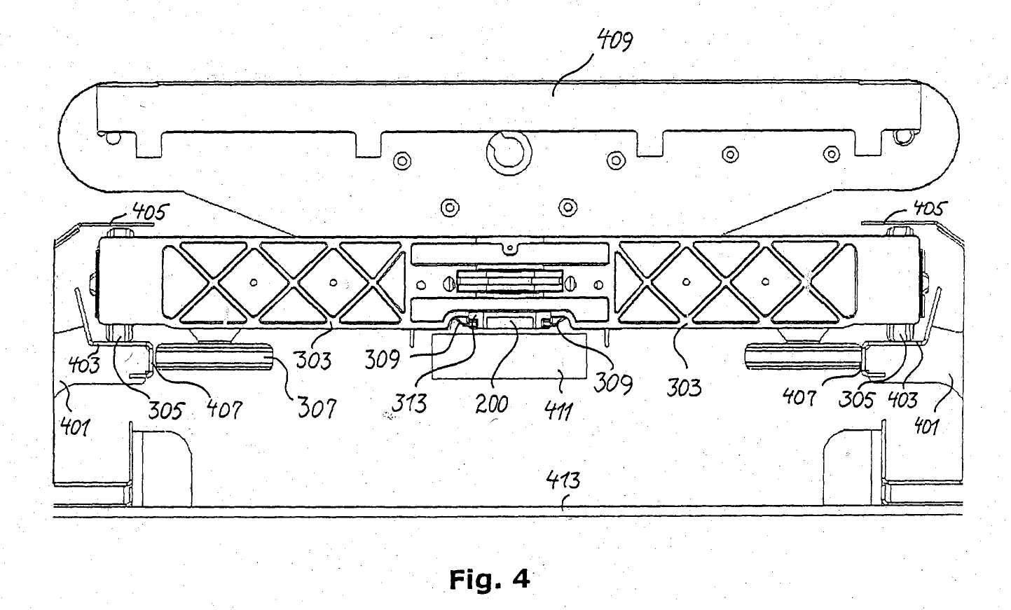

FIG. 4 is edge view of a cart 102 in accordance with a preferred embodiment of the invention when in position on a track.

The track is in the embodiment shown defined by guide rails 401. The guide rails 401 comprise support rails 403 upon which the vertically mounted wheels 305 of the cart rest. In addition, the support rails 403 comprise locking flanges 405 which restrict an upwards movement of the vertical wheels 305, thereby preventing the cart from jumping of the support rails 403. Further, the guide rails 401 have a profile providing guide edges 407. The horizontally mounted wheels 307 of the cart 102 abut the guide edges 407 in operation such that any significant sideways movement of the cart relative to the track is prevented.

The cart 102 in operation comprises a load bearing platform (article supporting surface) 409. An article, such as a parcel, piece of baggage or other load to be transported by the conveyor is loaded onto the load bearing platform by any suitable mechanism. Similarly, after the load has been transported to the appropriate position, it is off-loaded by any suitable mechanism. Specifically, the cart may comprise a tilting mechanism whereby the load bearing platform can be tilted relative to the guide rails 401 such that any load on the load bearing platform will slide off. Alternatively, the cart may comprise a flexible member e.g. in the form of a cross-belt whereby the load may be discharged by moving the flexible member in a direction substantially perpendicular to the conveyance direction, i.e. to the guide rails 401. Other discharge means may also be used.

FIG. 4 illustrates a cart 102 comprising a reaction element 200 covered by the cover element 313 and in position within the frame structure 309. In addition, FIG. 4 illustrates a stationary stator 411. The mounting of the stator 411 is not shown but may for example simply be by one or more support elements mounted on the stator and fixed to the floor 413. The stator is mounted such that when the cart 102 moves over the stator 411, the gap is very small, preferably less than 5 mm and advantageously between 1.2 mm and 4 mm.

In operation, an electrical power is supplied to a coil assembly of the stator. The power is supplied in such a way that as the cart moves over the stator, the magnetic field generated by the coil assembly interacts with the magnetic element of the permanent magnets of the reaction block so as to generate a driving force on the cart 102. Specifically as the cart is approaching the stator, the supply of the electric power is such that the magnetic field of the stator generates an attractive magnetic force pulling the cart 102 towards the stator 411. As the reaction element 200 passes over the stator 411, the magnetic field is reduced to zero and as the cart 102 passes over the stator 411, the magnetic field is reversed such that the magnetic force on the cart 102 acts to push the cart away from the stator. As a chain of carts 102 preferably all have reaction elements 200, the magnetic field of the stator 411 oscillates as the chain moves over the stator 411. The electrical power supplied to the stator 411 is carefully controlled such that it corresponds to the magnetic field changes caused by the reaction elements 200 at the speed at which the carts 102 are moving. The speed of the carts can be increased and/or decreased by changing the frequency of the electrical power supplied to the stator.

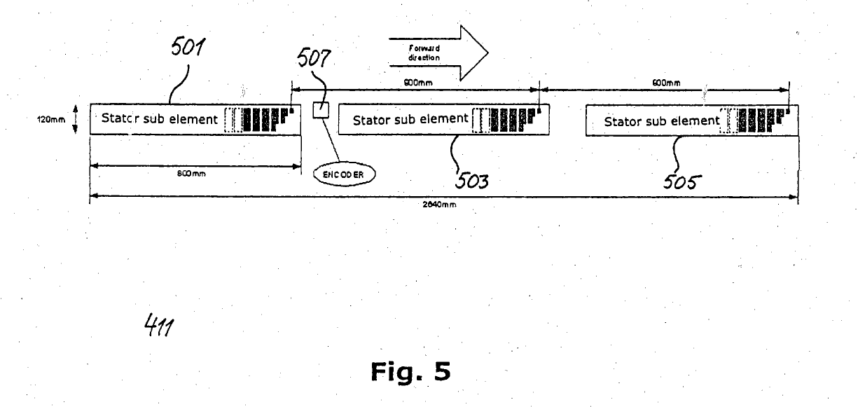

FIG. 5 illustrates an example of a stator 411 in accordance with an embodiment of the invention. In the example, the stator 411 comprises three drive elements 501, 503, 505. Each of the drive elements 501, 503, 505 comprises a coil assembly and produces a magnetic field in response to electrical power being supplied. The dimensions are designed to suit the size of the carts, and in the specific embodiment each sub element is 800 mm and the distance between drive elements is 900 mm. The electrical power supply to the drive elements is such that all drive elements create a driving force exerted on the chain of carts. However, specifically, each drive element may act on a separate cart and the total driving force equals the sum of the driving force applied to the individual carts 102 having reaction elements 200 interacting with the drive elements 501, 503, 505.

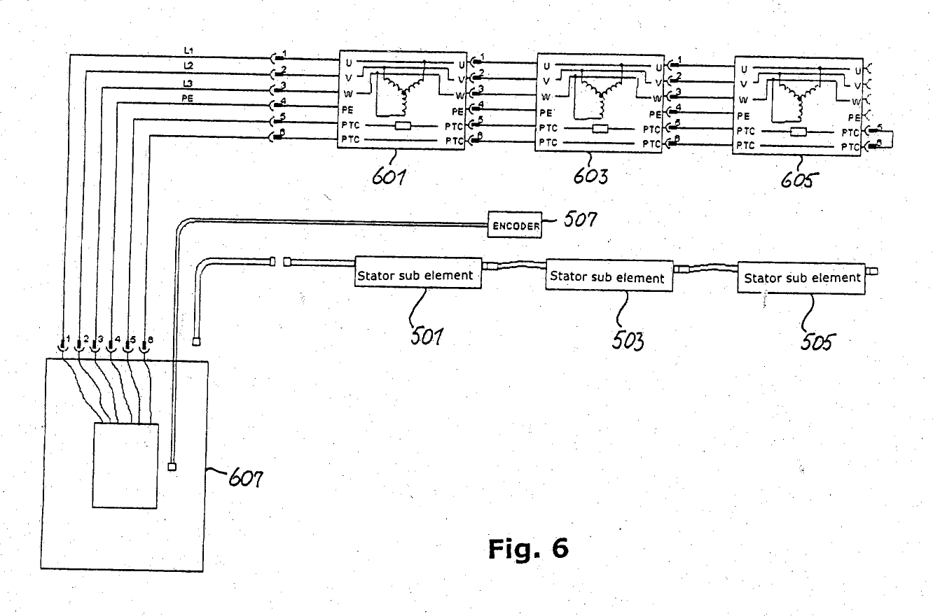

FIG. 6 illustrates the electrical control system for a stator of a conveyor in accordance with a preferred embodiment of the invention. Each of the three drive elements 501, 503, 505 of the stator 411 has an associated connection box 601, 603, 605 for the coil assemblies. In the present embodiment, the coil assemblies and thus the connection boxes utilise a three phase alternate current power supply. The connection box of each of the drive elements 501, 503, 505 is thus connected to a controller 607 which provides the three phase electrical power as required to drive the magnetic field of the stator 411 appropriately. The connection box 603 of the second drive element 503 is connected to the controller 607 through the first connection box 601 and the connection box of the third drive element 505 is connected to the controller 607 through the first two connection boxes 601, 603.

In addition each drive element comprises a PTC (positive temperature coefficient) resistor which is connected to the controller 607 in the same fashion. The value of the PTC resistor depends on the temperature of the resistor, and the controller can therefore detect temperature increases in the drive elements and shut down a drive element if it is overheating.

As shown in FIGS. 5 and 6, the conveyor in the preferred embodiment further comprises an encoder 507 which ideally is positioned between the stator drive elements. The encoder detects when a cart is adjacent the encoder, and additionally or alternatively the speed at which the cart is moving. Any suitable method of detecting a location and/or speed of a cart 102 can be used. A simple method comprises directing two light beams across the track and detecting when these light beams are broken by a cart. The speed of the cart is then determined from the distance between the light beams and the time difference between the light beams being broken. The speed and position determination is used by the controller 607 to synchronise the electrical power supplied to the drive elements to the movement of the carts 102 such that the magnetic fields are synchronised.

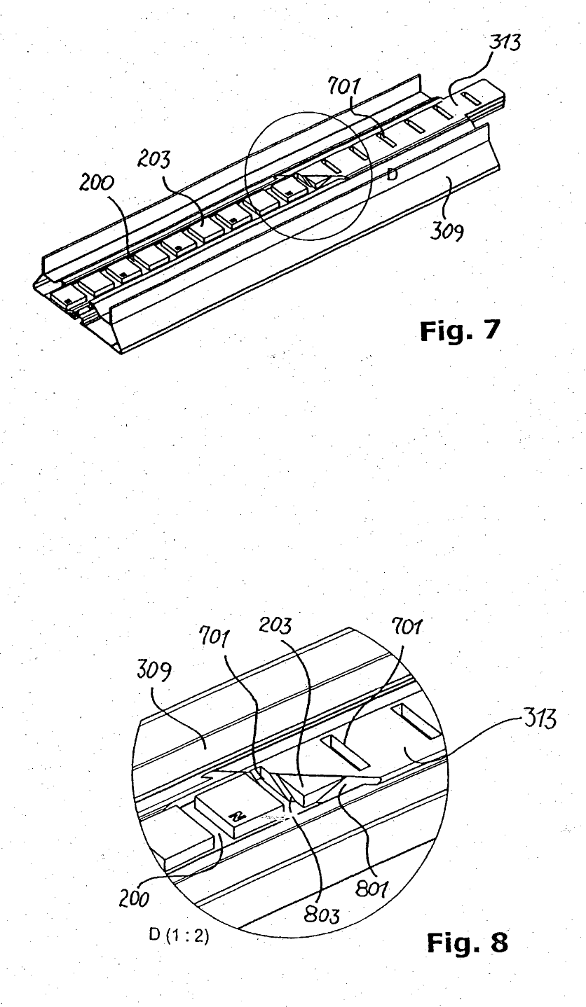

FIG. 7 illustrates a reaction element 200 being mounted in a frame structure 309 with a protective cover 313 in accordance with an embodiment of the invention and FIG. 8 is a close up of the reaction element 200 and mounting of the embodiment of FIG. 7.

As illustrated in FIGS. 7 and 8 the protective cover is manufactured such that it complements the reaction element 200 and specifically the permanent magnets 203 on the reaction element 200. The protective cover 313 fits over the reaction element 200 such that flanges of the protective cover 801 and 803 are in close proximity or preferably abuts the permanent magnets 203. This provides a firm grip of the permanent magnets thereby assisting in fixing them to their position on the carrier plate and reducing the risk of any relative movement of the permanent magnets. In addition, the protective cover 313 provides protection of each individual magnet against any mechanical shock or vibration that may occur. The protective cover 313 furthermore comprises a cavity 701 between the permanent magnets 203. This gap improves the flexibility of the protective cover 313 and facilitates fitting the protective cover 313 on the reaction element 200. In addition, it attenuates any mechanical pressure or shock wave travelling through the protective cover 313. Finally, a material saving and thus weight reduction is obtained.

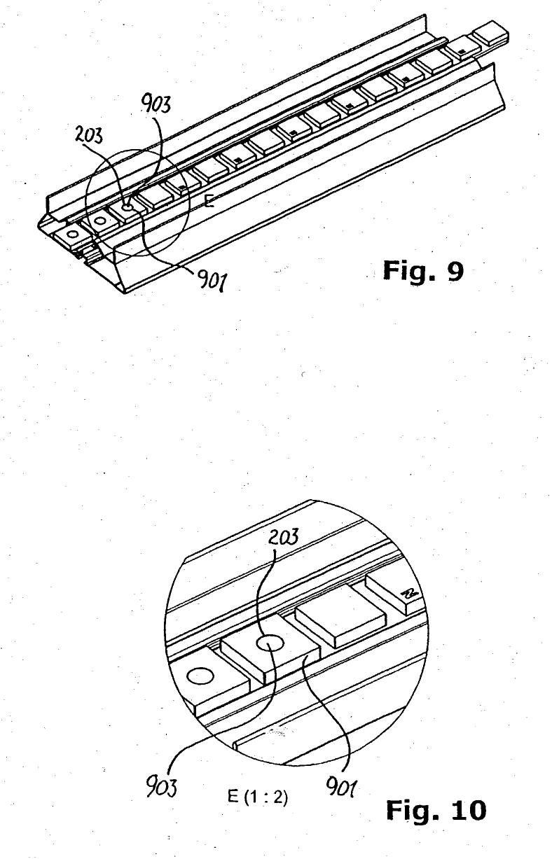

FIG. 9 illustrates a reaction element according to a different embodiment of the invention and FIG. 10 is close up of the same embodiment.

In this embodiment, the individual permanent magnets 203 are separately coated. This coating 901 is simple to apply, has low material use and low weight yet provides protection against mechanical shock and vibration. Specifically, it prevents the corners of permanent magnets from chipping as it provides for a smooth exterior with rounded edges. Specifically, the coating 901 does not completely surround the permanent magnet but leaves a gap 903. However, preferably the coating covers corners and narrow edges of the permanent magnets.

In accordance with one embodiment of the invention, the carrier plate of the reaction element is secured to the frame structure by the reaction element being positioned at an appropriate position in the frame structure after which liquefied plastic is poured over the construction, such that when the plastic solidifies it contacts both the permanent magnets as well as the frame structure. Hence, fixing of the reaction element to the frame structure and providing a protective cover is achieved in a single operation.

1. A conveyor comprising:
a chain of carts for carrying items,
a track along which the chain of carts may be driven,
a propulsion system for providing a driving force to the chain of carts for moving the carts along the track,
the propulsion system comprising:
at least one stationary stator comprising a coil assembly, whereby a first magnetic field may be generated by the coil assembly when electrical power is applied to the coil assembly,
at least one reaction element mounted on the chain of carts, the reaction element comprising a plurality of permanent magnets mounted on a ferromagnetic carrier plate, the permanent magnets thereby providing at least one second magnetic field, and
a controller for controlling a supply of electrical power applied to the coil assembly such that the first and second magnetic fields interact to provide the driving force.

2. A conveyor according to claim 1, wherein a gap between the stator and the reaction element is at most 5 mm at a position of the reaction element where it is in its closest position with respect to the stator.

3. A conveyor according to claim 2 wherein, the gap between the stator and the reaction element is between 1.2 and 4 mm at the position of the reaction element where it is in its closest position with respect to the stator.

4. A conveyor according to claim 1, wherein the conveyor is arranged to convey and sort items.

5. A conveyor according to claim 1, wherein the chain of carts is an endless chain.

6. A conveyor according to claim 1, wherein the at least one reaction element comprises a number of reaction elements equal to the number of carts in the chain, whereby each cart is provided with one such reaction element.

7. A conveyor according to claim 1 and comprising a plurality of stators arranged at intervals along the track.

8. A conveyor according to claim 7 wherein the plurality of stators is arranged substantially equidistantly along the track.

9. A conveyor according to claim 1, wherein the controller is operable to control a speed of the chain of carts by controlling a frequency of a voltage applied to the coil assembly.

10. A conveyor according to claim 1, wherein the controller comprises a control system for controlling the operation of the propulsion system, the control system comprising a variable frequency inverter for controlling the electrical power applied to the coil assembly.

11. A conveyor according to claim 10, wherein the control system is comprised in an industrial network.

12. A conveyor according to claim 1, wherein the controller further comprises an encoder for determining a position of at least one cart of the chain of carts, and the controller is operable to control the electrical power applied to the coil assembly in response to the determined position.

13. A conveyor according to claim 1, wherein the controller further comprises an encoder for determining a speed of at least one cart of the chain of carts, and the controller is operable to control the electrical power applied to the coil assembly in response to the determined speed.

14. A conveyor according to claim 13, wherein the encoder is mounted in a magnetically shielded housing.

15. A conveyor according to claim 13, wherein the at least one stationary stator comprises at least two drive elements each having a coil assembly and the encoder is mounted between two adjacent drive elements.

16. A conveyor according to claim 1, wherein each stator of the propulsion system is capable of providing a driving force of at least 350 N.

17. A conveyor according to claim 1, wherein a magnetic flux induced by the propulsion system is at most 0.8 kA/m in a distance of 0.2 m from the stator and the at least one reaction element.

18. A conveyor according to claim 1, wherein at least one cart of the chain of carts comprises magnetical shielding material.

19. A parcel sorting system comprising a conveyor according to claim 1.

20. A baggage sorting system comprising a conveyor according claim 1.

21. A method of providing a driving force to a conveyor comprising:
a chain of carts for carrying items,
a track along which the chain of carts may be driven,
a propulsion system for providing a driving force to the chain of carts for moving the carts along the track, the propulsion system having at least one stationary stator and at least one reaction element mounted on the chain of carts, the reaction element comprising a plurality of permanent magnets mounted on a ferromagnetic carrier plate thereby generating at least one reaction magnetic field,
the method comprising:
generating a first magnetic field in a coil assembly of the at least one stationary stator by applying electrical power to the coil assembly, and
controlling the supply of electrical power applied to the coil assembly such that the first magnetic field and the at least one reaction magnetic field interact to provide the driving force.

22. A method according to claim 21, wherein the step of controlling the supply of electrical power comprises controlling a speed of the chain of carts by controlling a frequency of a voltage applied to the coil assembly.

23. A method according to any of the claims 21 further comprising the step of determining a position of at least one cart of the chain of carts, and wherein the control of the supply of electrical power is in response to the determined position.

24. A method according to any of the claims 21 further comprising the step of determining a speed of at least one cart of the chain of carts, and wherein the control of the supply of electrical power is in response to the determined speed.

25. A cart for a conveyor according to claim 1, the conveyor having a propulsion system, the cart comprising:
a frame structure,
at least one magnetic reaction element comprising a plurality of permanent magnets mounted at intervals on a ferromagnetic carrier plate,
a protective cover of a non-magnetic material covering the permanent magnets for protection against mechanical impact.

26. A cart according to claim 25 wherein the plurality of permanent magnets is mounted substantially equidistantly.

27. A cart according to claim 25, wherein the protective cover comprises a plastic coating.

28. A cart according to claim 27, wherein the protective cover is integral with a plastic filling which fills the intervals between the magnets.

29. A cart according to claim 28, wherein the protective cover and the plastic filling are integral with at least one plastic element for fastening the carrier plate to the frame structure.

30. A cart according to claim 28, wherein each magnet is covered by a separate coating.

31. A cart according to claim 25, further comprising a fastening element for fastening the carrier plate to the frame structure.

32. A conveyor system comprising a plurality of carts according to claim 25.

33. A method of securing a carrier plate to a frame structure of a cart for a conveyor, the cart comprising:
at least one magnetic reaction element comprising a plurality of permanent magnets mounted at intervals on a ferromagnetic carrier plate,
a protective cover of a plastic material covering the permanent magnets for protection against mechanical impact,
the method comprising:
arranging the carrier plate in a predetermined position with respect to the frame structure,
providing the plastic material in a liquefied state to the carrier plate such that the plastic material covers the permanent magnets and, once solidified, provides a fastening connection between the carrier plate and the frame structure.
